(19) United States
(12) Patent Application Publication
(10) Pub. No.: US 2025/0205793 A1
(43) Pub. Date: Jun. 26, 2025

(54) AN INTEGRALLY FORMED TOOL ARM FOR A POWER CUTTER

(71) Applicant: HUSQVARNA AB, Huskvarna (SE)

(72) Inventors: Fredrik KARLSSON, Huskvarna (SE); Daniel ERICSON, Huskvarna (SE); Paul JOHANSSON, Huskvarna (SE); Fredrik LARSSON, Huskvarna (SE)

(21) Appl. No.: 18/846,263

(22) PCT Filed: Mar. 20, 2023
(86) PCT No.: PCT/SE2023/050236

§ 371 Date: Sep. 12, 2024

(30) Foreign Application Priority Data
Mar. 31, 2022 (SE) 2250405-4

(51) Int. Cl. B23D 45/00; B23D 45/16; B23D 47/02; E01B 31/04

(52) U.S. Cl. CPC B23D 45/006; B23D 45/16; B23D 47/02; E01B 31/04

(57) ABSTRACT

An integrally formed tool arm for a power cutter, the tool arm comprising a first aperture (310) for receiving a motor axle, a second aperture (320) for receiving a tool axle of a rotatable work tool, wherein the first aperture (310) and the second aperture (320) are intersected by and orthogonal to a longitudinal extension axis of the tool arm, the tool arm further comprising first rail cutting accessory attachment means (330) arranged to receive a rail cutting accessory, wherein the first rail cutting accessory attachment means (330) is arranged offset from the longitudinal extension axis of the power cutter arm.

### TECHNICAL FIELD

The present disclosure relates to hand-operated construction equipment. There are disclosed tool arms and other components for use in power cutter assemblies arranged to cut rails and other metal objects.

### BACKGROUND

Power cutters are hand-held power tools comprising rotatable cutting discs arranged for abrasive operation. A power cutter is normally used to cut hard materials such as concrete and stone. However, cutting discs suitable for cutting larger metal objects are also available. Such cutting discs can be used with advantage to cut steel rails for railway tracks.

When cutting steel rails for a railway track it is important that the cut is straight, i.e., perpendicular to the extension direction of the rail, and has even surfaces, since a non-straight and/or uneven cut makes assembly of the railway track more difficult. Therefore, rail cutting accessories have been developed which hold the power cutter fixedly in position in relation to the rail. CN113290289 A describes an example of this type of rail cutting accessory. EP2106316B1 describes another example rail cutter assembly.

However, despite the work done to-date, there is a continuing need for improvements in power cutters for cutting rails.

### SUMMARY

It is an objective of the present disclosure to provide improved power cutters for cutting rails. This objective is obtained by an integrally formed tool arm for a power cutter. The tool arm comprises a first aperture for receiving a motor axle and a second aperture for receiving a tool axle of a rotatable work tool.

The first aperture and the second aperture are intersected by and orthogonal to a longitudinal extension axis of the tool arm. The tool arm further comprises first rail cutting accessory attachment means arranged to receive a rail cutting accessory, wherein the first rail cutting accessory attachment means is arranged offset from the longitudinal extension axis of the power cutter arm.

By forming the tool arm with the apertures for receiving the motor axle and the tool axle and the first rail cutting accessory attachment means in a single piece, i.e., by integrally forming the tool arm, an increased mechanical strength is obtained. The tool arm is preferably formed in a metal material, such as magnesium, aluminum, or steel. This type of tool arm which supports the motor axle, the tool axle, and the rail cutting accessory by a single piece of metal allows a high level of mechanical rigidity while also being possible to form in a light-weight and compact manner, which is an advantage in hand-held construction equipment.

A commonly used rail cutting accessory attachment means is a tubular aperture which extends transversal to the longitudinal extension direction of the tool arm. The rail cutting accessory then comprises a bolt or other form of protruding member arranged to be received and rotatably held in the tubular aperture. A length of this form of tubular aperture, measured orthogonally to the longitudinal extension axis of the tool arm and parallel to the motor axle and/or parallel to the tool axle, is at least 30 mm. The integrally formed tool arm provides a mechanically rigid connection between the rail cutting accessory and the tool axle which holds the cutting disc. This mechanically rigid link ensures evenly cut rails.

According to some aspects, the tool arm also comprises second rail cutting accessory attachment means arranged on an opposite side of the rotatable work tool. This second rail cutting accessory attachment means allows a rail cutting accessory to be attached on either side of the rotatable work tool.

The tool arm optionally comprises at least one structural reinforcement section configured to further increase the structural integrity of the tool arm. Such structural reinforcement sections may for instance be formed as honey-comb structures, which is a type of structure that provides increased mechanical strength at relatively low weight, which is an advantage.

According to some aspects, the tool arm comprises body attachment means for attaching the tool arm to a main body of the power cutter. The body attachment means are then arranged offset from the longitudinal extension axis of the power cutter arm. By offsetting attachment points from the longitudinal extension axis, an increased resilience to torsion is obtained. The tool arm may comprise a first structural reinforcement section configured to increase a structural integrity of the tool arm. The first structural reinforcement section extends along a line between the body attachment means and the first rail cutting accessory attachment means, thereby directly connecting the body attachment means to the first rail cutting accessory attachment means by the material of the tool arm. The body attachment point can be separated from the first rail cutting accessory attachment means by a plane orthogonal to the longitudinal extension axis of the power cutter arm and intersecting a midpoint between the first aperture and the second aperture. This type of geometry of the tool arm distributes forces evenly over the tool arm to resist both bending forces and torsion forces that affect the tool arm during use.

The first rail cutting accessory attachment means is preferably arranged offset towards the second aperture from the midpoint between the first aperture and the second aperture, i.e., the rail cutting accessory is preferably located close to the tool axis. This relative positioning of the rail cutting accessory and the tool axis is an advantage since this improves the mechanical strength of the connection between the tool axis and the rail cutting accessory. It is realized that the portion of the tool arm which connects the first rail cutting accessory attachment means to the tool axis is of importance when it comes to ensuring sufficient mechanical rigidity of the tool arm, since this portion is of the tool arm is the main link between the rail to be cut and the rotatable cutting disc which cuts the rail.

According to some aspects, the tool arm comprises a second reinforcement structure arranged at least partly in-between the first aperture and the second aperture and in connection to the first rail cutting accessory attachment means. This second reinforcement structure provides further increases to the mechanical strength of the tool arm. In particular, the second reinforcement structure improves the mechanical link between the first and second apertures and the first rail cutting accessory attachment means. This reinforcement structure advantageously comprises a honey-comb pattern which increases the mechanical strength of the structure without adding significant weight to the tool arm.

The tool arm may also comprise drive pulley attachment means arranged in connection to the second aperture. The drive pulley attachment means is arranged offset from the second aperture in direction of the first rail cutting accessory attachment means.

According to some further aspects, the first rail cutting accessory attachment means and the second aperture are separated by a distance r. An area of a circle centered on the rail cutting attachment means and with radius r overlaps with the tool arm to a degree of at least 40% as seen from the side of the tool arm in a direction parallel with a center axis of the rail cutting attachment means. This means that a significant portion of the material of the tool arm is located in vicinity of the first rail cutting accessory attachment means and the second aperture, providing an increased strength mechanical connection between the rail cutting accessory and the cutting tool.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIGS. 1A-B show an example power cutter arranged for cutting rails;

FIG. 2 illustrates an example rail cutting accessory in use;

FIG. 3 illustrates geometrical relationships of parts of a power cutter arm;

FIGS. 4A-E show views of an example power cutter arm;

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

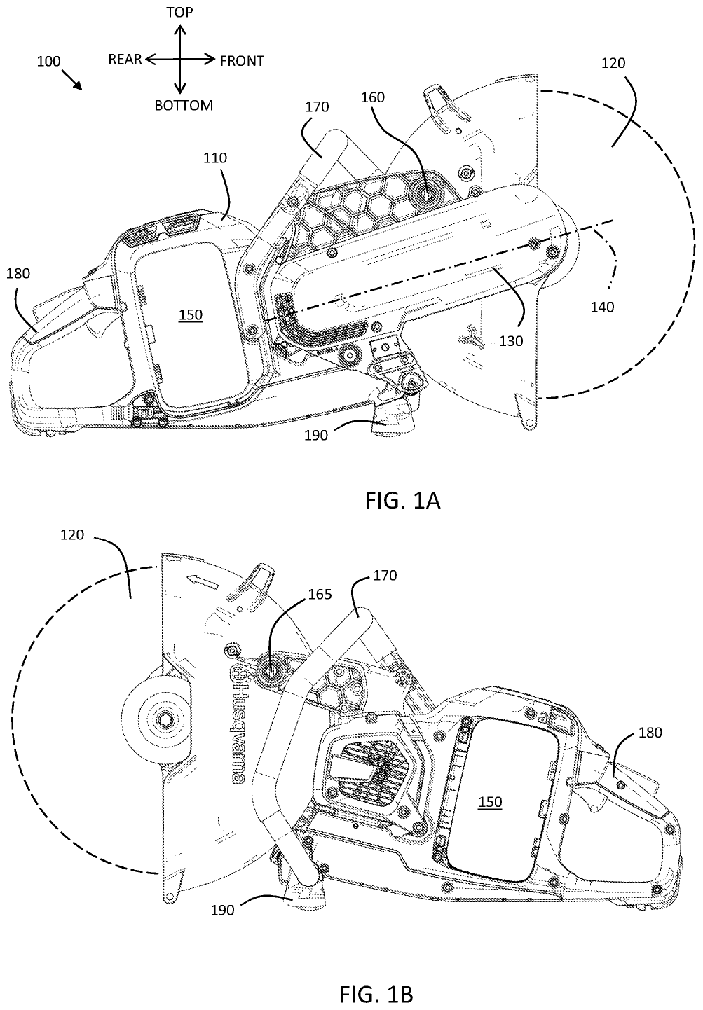

FIGS. 1A and 1B shows a power cutter 100, i.e., a hand-held work tool for cutting hard material work objects. The power cutter 100 comprises a main body 110 with a motor (not shown in FIG. 1) connected to a rotatable circular cutting tool 120 via a power cutter tool arm 130. The tool arm 130 extends along a longitudinal extension axis 140 from a rotation center of the motor axle to a rotation center of the tool 120. The tool arm 130 supports the rotatable tool in relation to the power cutter main body. The power cutter 100 comprises a front handle 170, a rear handle 180, and a ground support member 190. The front handle 170 is arranged distanced from the ground when the power cutter is not in use and in resting position supported by the ground support member 190. The rear handle 180 is arranged on the opposite end of the power cutter compared to the rotatable circular cutting tool 120, i.e., distal from the cutting tool.

The relative positions of components of the power cutter 100 as well as the different parts of the tool arm 130 can be described in terms of a top, bottom, rear and front direction as indicated in FIG. 1.

The tool arm 130 in FIG. 1A and FIG. 1B comprises a cover which at least partly encloses an internal volume of the tool arm, in the example tool 100, the cover is a plastic cover, but other materials may also be used.

A drive arrangement connecting the motor to the cutting tool is enclosed by the tool arm, where it is protected against dust and slurry. This drive arrangement may comprise, e.g., pulleys and a drive belt, possibly combined with one or more gears. The tool arm 130 supports the components of the drive arrangement.

This particular example power cutter 100 is an electrically powered work tool arranged to receive an electrical energy source, i.e., a battery or other form of electrical energy storage, in a compartment 150. However, the tool arms, tool components and design techniques discussed herein are also applicable to combustion engine powered work tools and electrical tools powered via cable from electrical mains.

The power cutter 100 comprises first rail cutting accessory attachment means 160 arranged to receive a rail cutting accessory. The first rail cutting accessory attachment means 160 is arranged offset from the longitudinal extension axis 140 of the power cutter arm 130 towards the front handle 170 of the power cutter 100 as illustrated in FIGS. 1A and 1B. The first rail cutting accessory attachment means 160 is also offset to the rear from the rotation center of the cutting tool 120.

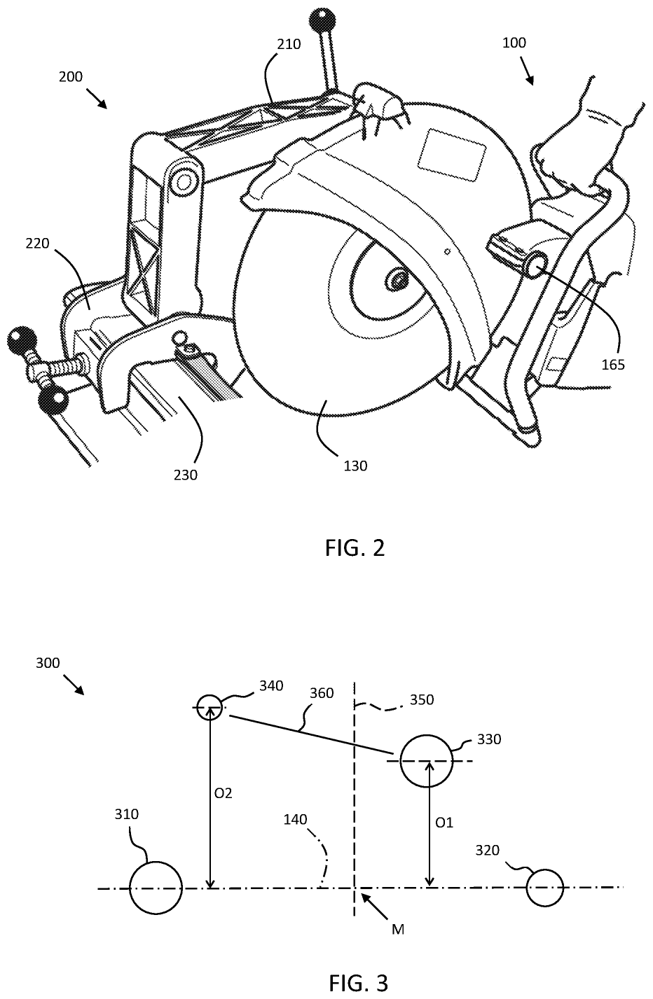

An example rail cutting accessory 200 is illustrated in FIG. 2. The rail cutting accessory 200 is used to hold the power cutter 100 in fixed relation with respect to a rail 230 to be cut. A first part 210 of the rail cutting accessory is arranged to mate with the first rail cutting accessory attachment means 160 of the power cutter 100. The power cutter can then be fixed to the rail 230 by the clamp 220, which is arranged to grip the rail. The first part 210 often comprises a bolt arranged to be received by a tubular member forming the first rail cutting accessory attachment means 160 of the power cutter 100. However, other attachment mechanisms are also possible. The first rail cutting accessory attachment means 160 can for instance comprise a bolt or other protruding member and the rail cutting accessory can instead comprise an aperture arranged to receive the protruding member of the first rail cutting accessory attachment means 160. Rail cutting accessories of this type are generally known and will therefore not be discussed in more detail herein.

A problem with many power cutters used for cutting rails is that the tool arm 130 is not of sufficient mechanical strength for ensuring straight cuts in the rails, i.e., the tool arm is not strong enough to resist bending and torsion during the cutting operation, which results in an uneven cut. It has been realized that this problem is due at least in part to that the tool arm 130 of the power cutter and the first rail cutting accessory attachment means are not integrally formed, i.e., molded or machined from a single piece of material. It is desired to increase the mechanical integrity of the tool arm, but since the weight of the power cutter is also an issue, it is desired to provide a tool arm 130 which does not add significantly to the overall weight of the power cutter 100.

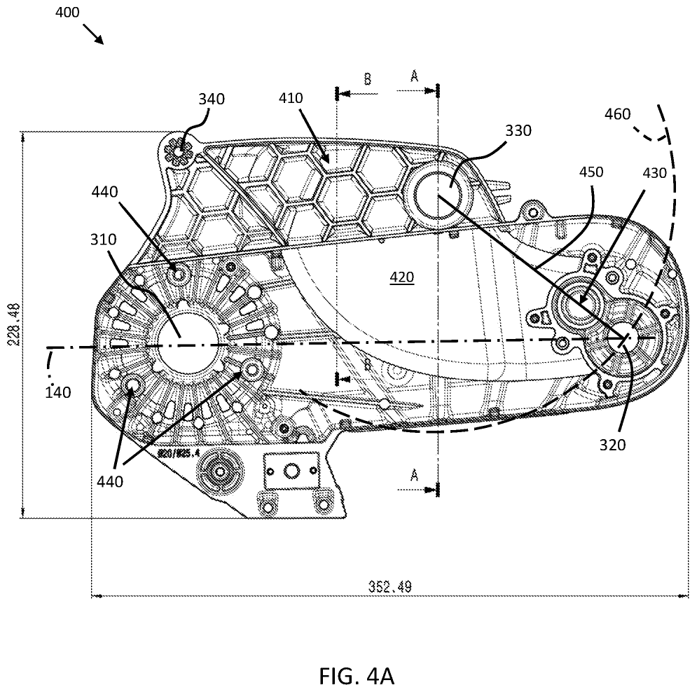

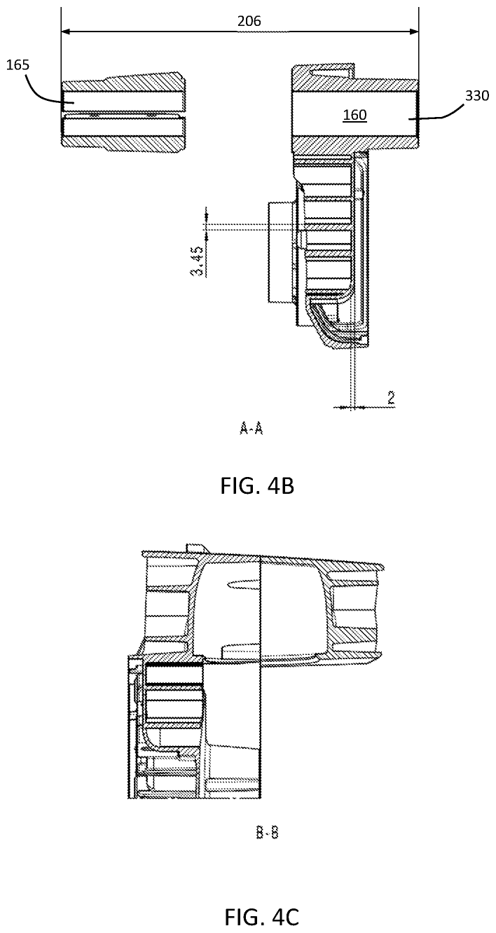

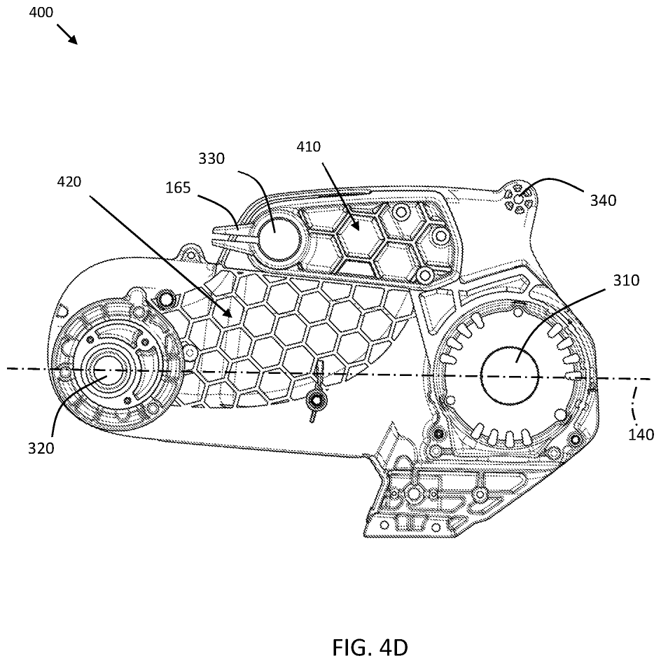

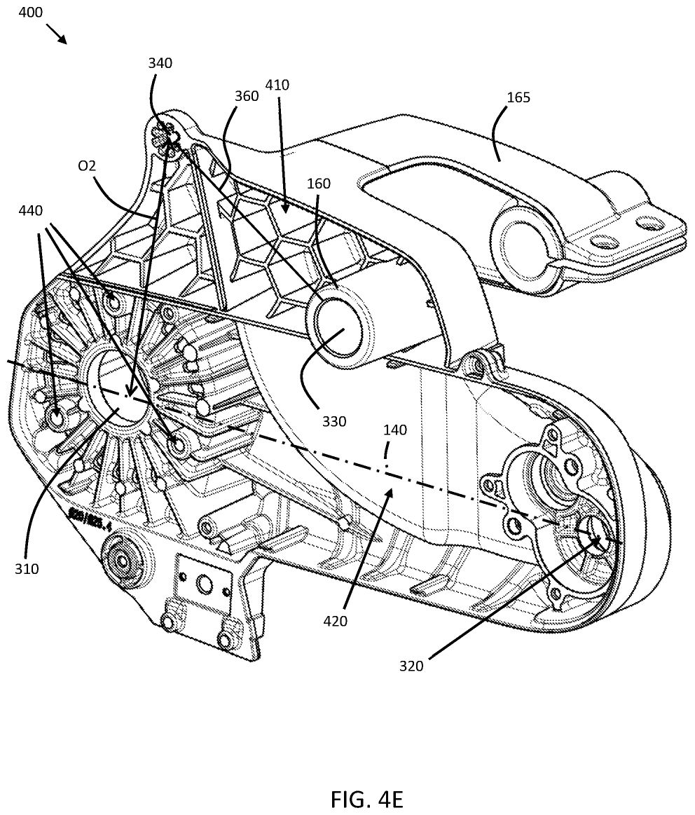

FIG. 3 schematically illustrates a geometry of the herein proposed tool arms, while FIGS. 4A-E show an example of an integrally formed tool arm of increased mechanical integrity. The dimensions shown in the drawings are example dimensions given in mm. The tool arm comprises a first aperture 310 for receiving a motor axle and a second aperture 320 for receiving a tool axle of a rotatable work tool 120. The example tool arm illustrated in FIGS. 4A-E also comprises bolt holes 440 for fixedly holding an electric machine in position. The motor axle extends out through the first aperture 310 where a first drive pulley can be attached. The first drive pulley on the motor axle then connects to a second drive pulley arranged at the other end of the tool arm via a drive belt in a previously known manner. The second drive pulley is secured to the tool arm by drive pulley attachment means 430. Optionally, a geared transmission is arranged in between the tool axle and the second drive pulley.

The first aperture 310 and the second aperture 320 are intersected by and orthogonal to the longitudinal extension axis 140 of the tool arm 130, 400. The extension axis 140 intersects a midpoint M in-between the first aperture 310 and the second aperture 320.

The tool arm 130, 400 further comprises first rail cutting accessory attachment means 330 arranged to receive a rail cutting accessory 200 such as the rail cutting accessory 200 illustrated in FIG. 2. The first rail cutting accessory attachment means 330 is arranged offset O1 from the longitudinal extension axis 140 of the power cutter arm 130 as illustrated in FIG. 3. Thus, the first aperture 310 where the motor axle is supported, the second aperture 320 where the tool axle is supported, and the first rail cutting accessory attachment means 330 where the rail cutting accessory is supported forms the corners of a triangle. This geometry of distanced support points provides an increased resistance to twisting of the tool arms, and also bending of the tool arm in response to external forces.

FIG. 4A and FIG. 4D show side views of an example tool arm 130. FIGS. 4B and 4C show cross-sectional views along A-A and B-B as indicated in FIG. 4A. Some example material dimensions are indicated in FIGS. 4B and 4C. FIG. 4A also illustrate some example tool arm dimensions.

The tool arm 130, 400 is preferably integrally formed in a metal material, such as magnesium, aluminum, or steel. Various alloys can of course also be used to form the single piece tool arm. To provide resistance against bending and torsion about the longitudinal axis 140, the tool arm 130, 400 optionally comprises at least one structural reinforcement section 410, 420 configured to increase a structural integrity of the tool arm. These structural reinforcement sections may for instance be formed as honeycomb structures that by design resist both bending and torsion movement in the tool arm. An advantage of using a honey-comb structure in this manner is that it does not add significantly to the weight of the tool arm, as a solid metal reinforcement structure would have done.

A width of the tool arm measured orthogonally to the longitudinal extension axis 140 of the tool arm 130, 400 and parallel to the motor axle and/or parallel to the tool axle is between 100 mm and 300 mm, which is a range of widths that has been found suitable for a tool arm of this kind. According to an example, the overall width of the tool arm is about 200 mm, as illustrated in FIG. 4B.

The tool arm 130, 400 is preferably produced in a material having a thickness of about 2 mm, such as between 1.5 mm and 3.5 mm. It is an advantage that the tool arm is not solid, but rather defines a volume delimited by the material in the tool arm, which may as mentioned above be partly filled by one or more reinforcement structures. By not having a solid tool arm, it becomes possible to arrange the drive pulleys and drive belt inside the tool arm where they are protected from dust and slurry, and also from impact by other objects. A hollow construction tool arm also has a smaller weight compared to a solid tool arm of the same dimensions, which is an advantage. A reinforcement structure such as a honey-comb structure may be of slightly increased material dimension compared to the other parts of the tool arm, e.g., between 3 mm and 4 mm, such as about 3.45 mm as illustrated in FIG. 4B.

With reference to FIG. 3 and, e.g., FIG. 4E, the tool arm 130, 400 may also comprise body attachment means 340 for attaching the tool arm 130, 400 to a main body 110 of the power cutter 100. The body attachment means 340 is preferably arranged offset O2 from the longitudinal extension axis 140 of the power cutter arm 130. This offset provides a geometry of the tool arm which better resists torsion. The offset O2 is preferably larger than the offset O1.

A first structural reinforcement section 410 is optionally arranged extending along a line 360 between the body attachment means 340 and the first rail cutting accessory attachment means 330. This connection between the body attachment means and the first rail cutting accessory attachment means 330 is provided to resist bending and torsion of the tool arm. The body attachment point 340 is advantageously separated from the first rail cutting accessory attachment means 330 by a plane 350 orthogonal to the longitudinal extension axis 140 of the power cutter arm 130 and intersecting a midpoint M between the first aperture 310 and the second aperture 320, as illustrated in FIG. 3. The first structural reinforcement section 410 illustrated in FIG. 4E also distributes forces over the tool arm, thereby reducing any tendencies of the tool arm to bend and/or twist about the longitudinal extension axis 140.

FIG. 4E also shows second rail cutting accessory attachment means 165 arranged on an opposite side of the rotatable work tool from the first rail cutting accessory attachment means 160. This second rail cutting accessory attachment means allows a rail cutting accessory to be attached on either side of the rotatable work tool, which is an advantage. The second rail cutting accessory attachment means 165 may be integrally formed with the tool arm 130, or attached by fastening members as illustrated in FIG. 4E.

With reference to FIG. 3, the first rail cutting accessory attachment means 330 is preferably arranged offset towards the second aperture 320 from the midpoint M between the first aperture 310 and the second aperture 320. This way the distance between the anchoring point of the rail cutting accessory and the tool axle is reduced which is an advantage. Generally, the longer the distance between the rail cutting accessory anchoring point and the tool axle the more prone to bending and torsion the tool arm becomes.

A second reinforcement structure 420 can be arranged at least partly in-between the first aperture 310 and the second aperture 320 and in connection to the first rail cutting accessory attachment means 330. This second reinforcement structure is configured to absorb unwanted mechanical movement in the tool arm, and in particular torsion around the longitudinal extension axis 140. An example of this second reinforcement structure 420 is shown in FIG. 4D.

The first rail cutting accessory attachment means 160, 330 may, as illustrated in e.g. FIG. 4B, be realized as a tubular aperture extending transversal to the longitudinal extension direction of the tool arm 130, 400. However, other forms of interfaces to the rail cutting accessory can also be used of course, such as bolts extending out from the tool arm or the like. A length of the tubular aperture, measured orthogonally to the longitudinal extension axis 140 of the tool arm 130, 400 and parallel to the motor axle and/or parallel to the tool axle is preferably at least 50 mm.

The tool arm 130, 400 optionally comprises drive pulley attachment means 430 arranged in connection to the second aperture 320. The drive pulley attachment means 430 can be arranged offset from the second aperture 320 in direction of the first rail cutting accessory attachment means 330.

Looking at, e.g., FIG. 4E, it is seen that a significant portion of the tool arm material is located in vicinity of the first rail cutting accessory attachment means 330 and the second aperture 320 where the cutting disc is supported on the tool axle. This large amount of tool arm material improves the mechanical rigidity between the rail cutting accessory and the cutting disc. Since the two are tightly held in relation to each other, the cut will be more straight compared to when using a tool arm of reduced mechanical integrity. With reference to FIG. 4A, it is noted that the first rail cutting accessory attachment means 330 and the second aperture 320 is separated by a distance r 450. An area of a circle 460 centered on the rail cutting attachment means 330 and with radius r overlaps with the tool arm 400 to a degree of at least 40%, and preferably at least 50%, as seen from the side of the tool arm in a direction parallel with a center axis of the rail cutting attachment means 330.

1. An integrally formed tool arm for a power cutter, the tool arm comprising
a first aperture for receiving a motor axle,
a second aperture for receiving a tool axle of a rotatable work tool,
wherein the first aperture and the second aperture are intersected by and orthogonal to a longitudinal extension axis of the tool arm,
the tool arm further comprising first rail cutting accessory attachment means arranged to receive a rail cutting accessory, wherein the first rail cutting accessory attachment means is arranged offset from the longitudinal extension axis of the tool arm.

2. The tool arm according to claim 1, integrally formed in a metal material.

3. The tool arm according to claim 2, wherein the metal material comprises any of magnesium, aluminum, and steel.

4. The tool arm according to claim 1, comprising at least one structural reinforcement section configured to increase a structural integrity of the tool arm.

5. The tool arm according to claim 4, wherein the at least one structural reinforcement section comprises a honeycomb structure.

6. The tool arm according to claim 4, wherein a width of the tool arm measured orthogonally to the longitudinal extension axis of the tool arm and parallel to the motor axle or parallel to the tool axle is between 100 mm and 300 mm.

7. The tool arm according to claim 1, wherein a material thickness of the tool arm is between 1.5 mm and 3.5 mm.

8. The tool arm according to claim 1, comprising body attachment means for attaching the tool arm to a main body of the power cutter, wherein the body attachment means is arranged offset from the longitudinal extension axis of the power cutter arm.

9. The tool arm according to claim 8, comprising a first structural reinforcement section configured to increase a structural integrity of the tool arm, wherein the first structural reinforcement section extends along a line between the body attachment means and the first rail cutting accessory attachment means.

10. The tool arm according to claim 8, wherein the body attachment point is separated from the first rail cutting accessory attachment means by a plane orthogonal to the longitudinal extension axis of the power cutter arm and intersecting a midpoint between the first aperture and the second aperture.

11. The tool arm according to claim 1, wherein the first rail cutting accessory attachment means is arranged offset towards the second aperture from the midpoint between the first aperture and the second aperture.

12. The tool arm according to claim 1, comprising a second reinforcement structure arranged at least partly in-between the first aperture and the second aperture and in connection to the first rail cutting accessory attachment means.

13. The tool arm according to claim 1, wherein the first rail cutting accessory attachment means is a tubular aperture extending transversal to the longitudinal extension direction of the tool arm.

14. The tool arm according to claim 13, wherein a length of the tubular aperture, measured orthogonally to the longitudinal extension axis of the tool arm and parallel to the motor axle or parallel to the tool axle, is at least 30 mm.

15. The tool arm according to claim 1, comprising drive pulley attachment means arranged in connection to the second aperture, wherein the drive pulley attachment means is arranged offset from the second aperture in direction of the first rail cutting accessory attachment means.

16. The tool arm according to claim 1, arranged to receive a plastic cover.

17. A The tool arm according to claim 1, wherein there is a distance between the center axis of the first rail cutting accessory attachment means and the center axis of the second aperture is separated by the distance, wherein an area of a circle centered on a center defined by the center axis of the rail cutting attachment means and with a radius equal to the distance, overlaps with the tool arm to a degree of at least 40%, as seen from a side of the tool arm.

18. A cut-off work tool comprising the tool arm according to claim 1.

19. A kit of parts comprising the tool arm according to claim 1 and a rail cutting accessory.
